(19) United States
(12) Patent Application Publication
(10) Pub. No.: US 2007/0246949 A1
(43) Pub. Date: Oct. 25, 2007

(54) Release actuation device for clipping apparatus

(75) Inventors: Chin-Wen Chou, Taipei Hsien (TW); Tsui-Jung Su, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/390,143

(22) Filed: Mar. 28, 2006

(51) Int. Cl. E05C 19/10

(52) U.S. Cl. 292/121

(57) ABSTRACT

A release actuation device for clipping apparatus includes a body which houses a sliding member being movable up and down. The sliding member drives a clipping member synchronously. The clipping member has an upper clipping portion and a lower clipping portion to form a clipping zone. The upper clipping portion is fastened to one end side of the sliding member through a movable linking element, and the movable linking element can drive the upper clipping portion to form a fan-shaped moving track. The upper clipping portion and the sliding member are interposed by an elastic element. The elastic element stores a returning elastic force when the upper clipping potion is moved. The returning elastic force is released to drive the upper clipping portion to an accurate return position when moving of the upper clipping portion stops. Through the elastic element, the released upper clipping portion can be opened rapidly to release a clipped article. Thus the clipping apparatus can securely clip the clipped article and also can be returned crisply and quickly release the clipped article.

### FIELD OF THE INVENTION

The present invention relates to a clipping apparatus and particularly to a release actuation device for clipping apparatus.

### BACKGROUND OF THE INVENTION

A clipping apparatus basically aims to couple two elements together or release one of the two elements through a simple operation. It generally is adopted on doors or the like. For instance, the door of the operation panel of household appliances usually uses such an apparatus. The conventional clipping apparatus have many types and are operated in different ways. The commonly adopted operation is depressing. A first depressing aims to clip, and a second depressing aims to release. A desirable clipping apparatus has to be simple to use, can clip firmly and does not get loose easily. To release the clipped article rapidly and crisply also are important. The design and structure of the clipping apparatus directly affect those characteristics.

R.O.C. patent publication No. M285631 entitled “Sideward clipping apparatus” discloses a clipping apparatus which has a seat containing a housing trough. The housing trough holds an elastic element and a guiding member. The housing trough also contains a sliding member directed by the elastic element and the guiding member at a first position in normal conditions and at a second position when being depressed. The sliding member has a movable linking element and a clipping pawl which has an upper clipping end and a lower clipping end. The lower clipping end at the initial force receiving stage drives the upper clipping end through the movable linking element to form a first fan-shaped moving track. The lower clipping end is in contact with the sliding member under the force and moves vertically to the second position to drive the upper clipping end to form a second fan-shaped moving track. The upper and lower clipping ends form a clipping zone when the sliding member is moved to the second position to clip an article.

When the sliding member is moved from the second position to the first position, the article is released. Due to the upper and lower clipping ends are linked by a flexible linking blade, when the article is released the flexible linking blade does not have enough return force. As a result, the upper and lower clipping ends cannot be opened rapidly to release the article. Even though it can securely clip the article, it cannot release the article quickly and crisply. It may still cause great inconvenience to users due to not being able to release the clipped article immediately.

### SUMMARY OF THE INVENTION

The primary object of the present invention is to solve the aforesaid disadvantage. The invention provides a release actuation device to release a clipped article quickly. It includes a body which holds a sliding member being movable up and down. The sliding member drives a clipping member at the same time. The clipping member has an upper clipping portion and a lower clipping portion that form a clipping zone. The upper clipping portion is fastened to one end side of the sliding member through a movable linking element, and the movable linking element can drive the upper clipping portion to form a fan-shaped moving track. The upper clipping portion and the sliding member are interposed by an elastic element. When the upper clipping portion is driven, the elastic element receives a force and stores a returning elastic force. When the upper clipping portion stops moving, the returning elastic force is released from the elastic element to move the upper clipping portion securely at the return position. When the clipped article is released, the elastic element provides an action force to open the upper clipping portion rapidly. Hence besides clipping the article firmly, it also can return crisply and release the clipped article rapidly.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIGS. 3A, 3B and 3C are schematic views of the invention in operating conditions.

FIG. 4 is a perspective view of another embodiment of the invention.

FIG. 5 is a perspective view of yet another embodiment of the invention.

FIG. 6 is a perspective view of still another embodiment of the invention.

### DETAILED DESCRIPTION OF THE PREFERRED EMBODIMENTS

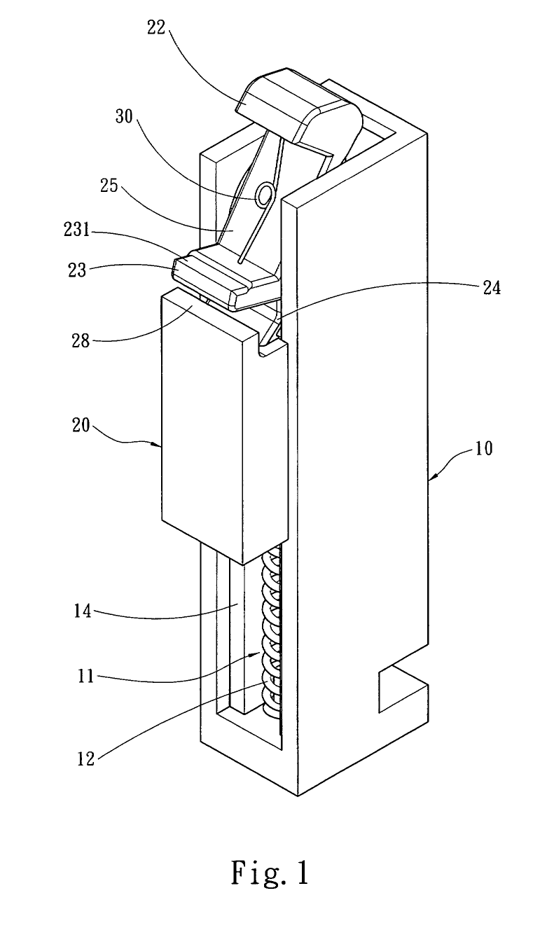

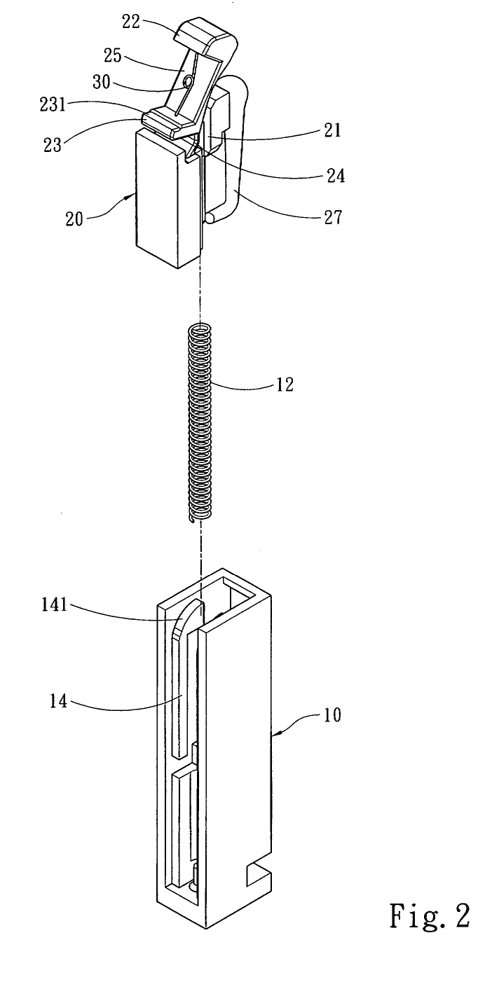

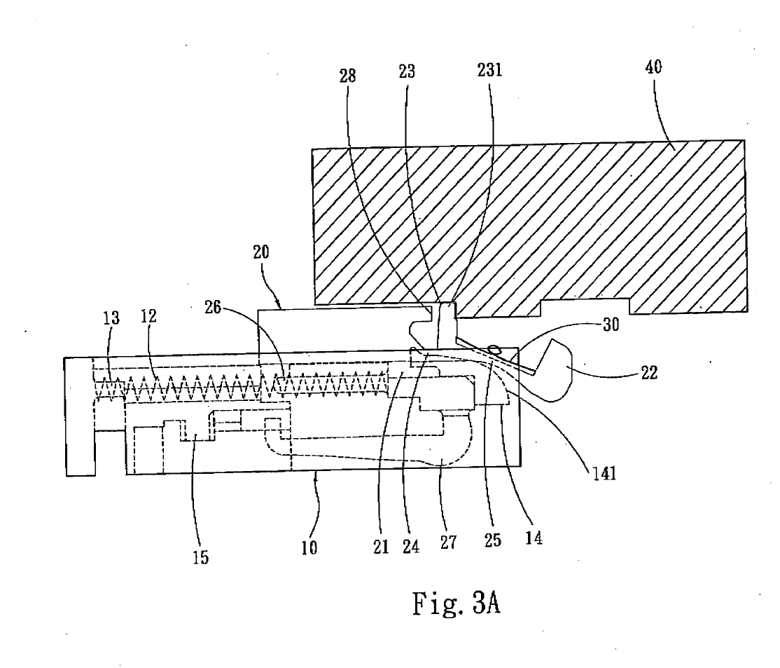

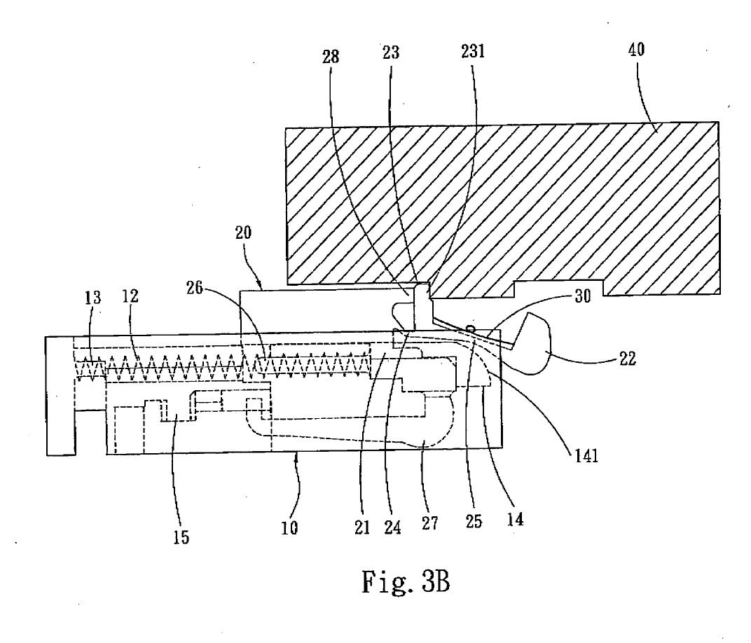

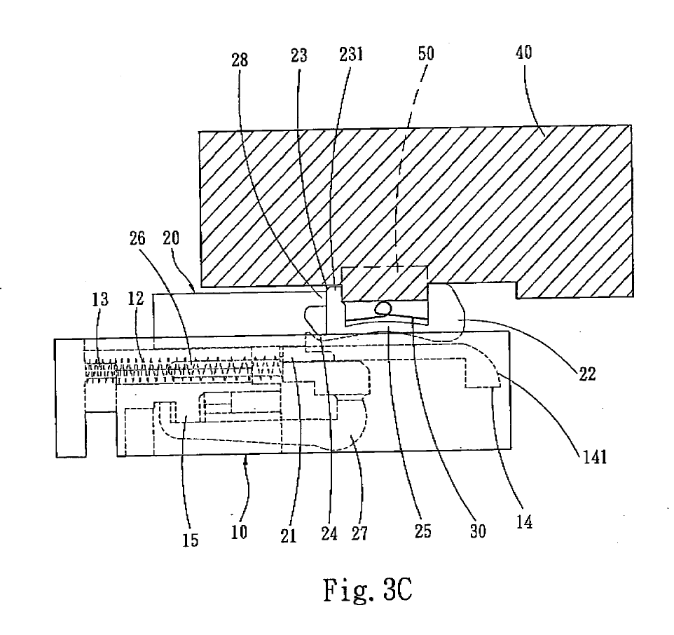

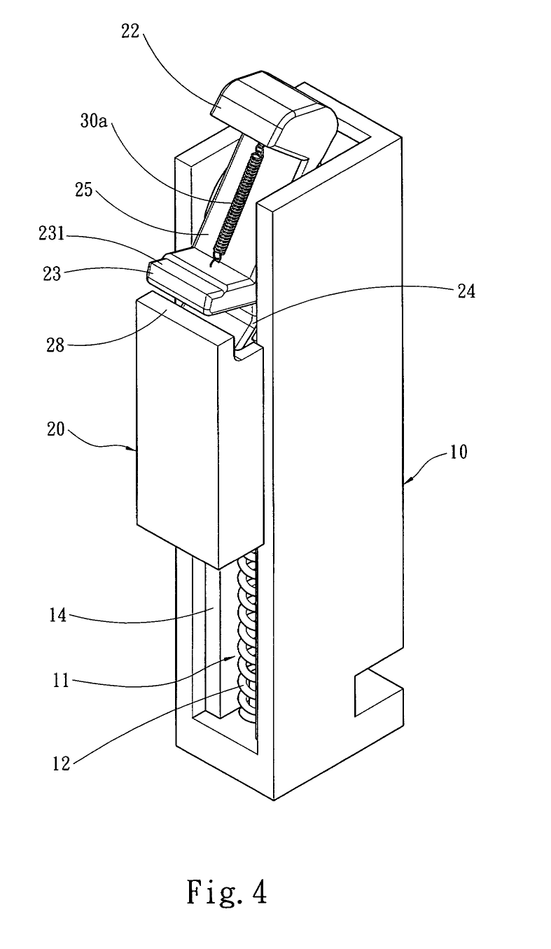

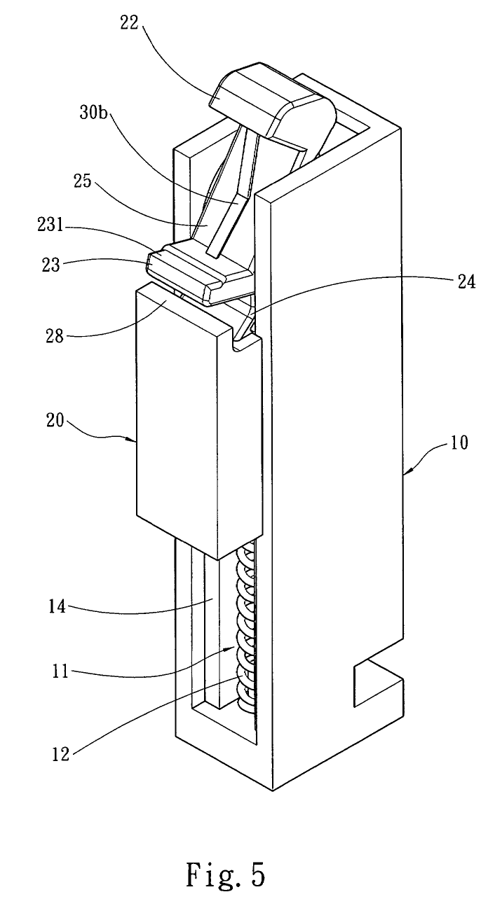

Please refer to FIGS. 1 and 2, the release actuation device according to the invention includes a body 10 which has a housing compartment 11. The housing compartment 11 houses an elastic element 12 and a detent member 15 (also referring to FIG. 3A). The housing compartment 11 also holds a sliding member 20. The body 10 and the sliding member 20 have respectively a guiding track 14 and a recess 21 that correspond to each other to prevent the sliding member 20 from escaping the body 10. The sliding member 20, through the elastic element 12 and a guiding portion 27 formed on the sliding member 20, can be moved in the housing compartment 11 at a first position in normal conditions and downwards to a second position when being depressed. The guiding portion 27 has one end located in the detent member 15. The detent member 15 defines a moving track interval of the moving path of the guiding portion 27 corresponding to the first and second positions of the sliding member 20. Hence the sliding member 20 can be moved between the first and second positions and also drive the guiding portion 27 in the moving track interval to form the moving path. When the sliding member 20 is located at the first and second positions and not depressed, the sliding member 20 is pushed by the elastic element 12 so that the guiding portion 27 is confined within the moving track interval of the detent member 15 and anchored on the first or second position. The sliding member 20 has a lower clipping portion 23 which is connected to the sliding member 20 by a movable linking element 24 in an integrated manner. The lower clipping portion 23 and an upper clipping portion 22 are connected through a flexible linking blade 25. The upper clipping portion 22 and the lower clipping portion 23 further are interposed by another elastic element 30. To make clipping more precise, the lower clipping portion 23 has a clipping surface 231 with an indentation directing upwards. Thereby a clipping zone 50 is formed between the upper and lower clipping portions 22 and 23.

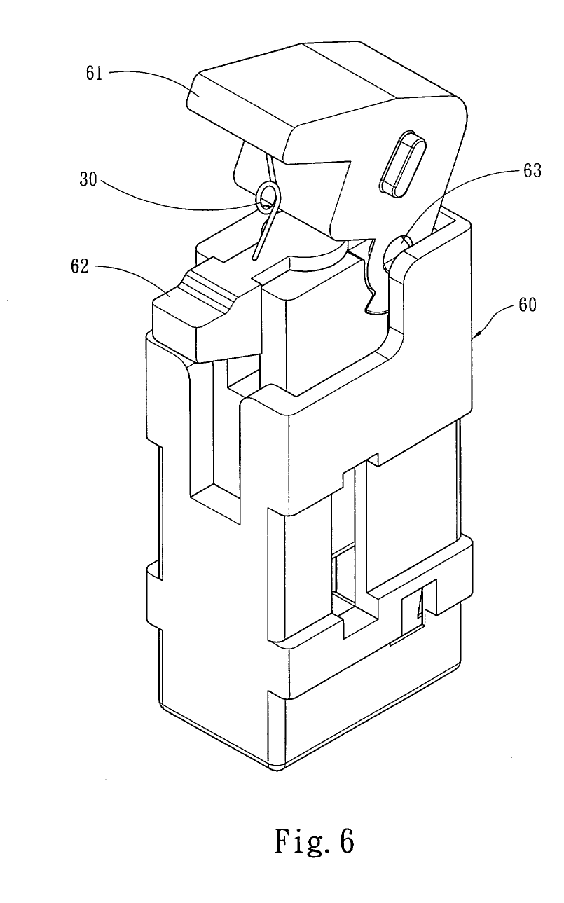

Referring to FIGS. 3A through 3C, when in use, the lower clipping portion 23 receives a force initially to drive the upper clipping portion 22 through the movable linking element 24 and the another elastic element 30, so that the upper clipping portion 22 and the lower clipping portion 23 are moved at the same time to form a first fan-shaped moving track (referring to FIGS. 3A and 3B); the lower clipping portion 23 continuously receives the force and is moved vertically to the second position, and drives the upper clipping portion 22 to form a second fan-shaped moving track; when the sliding member 20 is at the second position, the upper clipping portion 22 and the lower clipping portion 23 form the clipping zone 50 to clip a clipped article 40. In such a condition, the elastic element 12 and the another elastic element 30 between the upper and lower clipping portions 22 and 23 receive the force at the same time and store a potential energy (referring to FIG. 3C). Moreover, to aid forming the second fan-shaped moving track, the guiding track 14 has an arched portion 141 so that when the lower clipping portion 23 receives the force continuously, the linking blade 25 can move along the surface of the arched portion 141, to allow the upper clipping portion 22 to form the second fan-shaped moving track. To anchor the lower clipping portion 23 precisely or mate the profile of the clipped article 40, a moving space is formed between the sliding member 20 and the lower clipping portion 23, and form a pressing surface 28. Hence when the lower clipping portion 23 is depressed to form the first fan-shaped moving track and before the second fan-shaped moving track is formed, the pressing surface 28 can be precisely anchored on a clipping surface in the clipping zone 50. When the lower clipping portion 23 is depressed for the second time, the returning elastic force of the elastic element 12 pushes sliding member 20 back to the first position (referring to FIG. 3A). The elastic element 12 is held in the housing compartment 11 by corresponding anchor bosses 13 and 26 formed respectively on the body 10 and the sliding member 20. It provides the returning elastic force to move the sliding member 20 from the second position to the first position to release the clipped article 40. The invention provides a main feature as follow: the upper clipping portion 22 and the lower clipping portion 23 are interposed by the another elastic element 30. When the sliding member 20 is moved from the second position to the first position to release the clipped article 40, the another elastic element 30 stores the potential energy generated by compression of the upper clipping portion 22 on the clipped article 40. The returning elastic force pushes the upper clipping portion 22 quickly to form an opening angle relative to the lower clipping portion 23. Hence it can overcome the deficient returning force of the flexible linking blade 25 that cannot open the upper clipping portion 22 fast enough to quickly release the clipped article 40. Therefore the problems of the conventional clipping apparatus that offer less crisp and slow release operation can be eliminated. The another elastic element 30 is not limited to the bent metal strip as shown in the previous embodiment. Other types of elastic elements 30a and 30b such as a spring and an elastic reed can also be used. They also can release the returning elastic force to return the upper clipping portion 22 crisply. The implementation approach is the same as the one previously discussed. Details are omitted. The release actuation device of the invention can be used on a wide variety of clipping apparatus. FIG. 6 illustrates another embodiment in which an upper clipping portion 61 of the clipping apparatus 60 is linked through a coupling portion 63. A lower clipping portion 62 receives a force and drives the upper clipping portion 61 to form a clipping zone. The upper and lower clipping portions 61 and 62 are separated. The upper clipping portion 61 is coupled with an elastic element 30. Such a structure can also release the clipped article 40 quickly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A release actuation device for clipping apparatus, comprising:
a body which has a housing compartment;
a sliding member which is located in the housing compartment and movable up and down; and
a clipping member which is driven synchronously by the sliding member, and having an upper clipping portion and a lower clipping portion to form a clipping zone, the upper clipping portion being fastened to one end side of the sliding member through a movable linking element, and the movable linking element being able to drive the upper clipping portion to form a fan-shaped moving track, an elastic element being provided between the upper clipping portion and the lower clipping portion, the elastic element storing a returning elastic force when the upper clipping potion is moved, the returning elastic force being released to drive the upper clipping portion to an accurate return position when moving of the upper clipping portion stops.

2. The release actuation device for clipping apparatus of claim 1, wherein the lower clipping portion is integrally formed by extending one side of another end of the sliding member opposing the upper clipping portion.

3. The release actuation device for clipping apparatus of claim 1, wherein the lower clipping portion and the upper clipping portion are coupled together through the movable linking element on a same side of the sliding member.

4. The release actuation device for clipping apparatus of claim 1, wherein the elastic element is a spring.

5. The release actuation device for clipping apparatus of claim 1, wherein the elastic element is an elastic reed.
